(19) United States
(12) Patent Application Publication
(10) Pub. No.: US 2014/0170059 A1
(43) Pub. Date: Jun. 19, 2014

(54) ELECTRODIAPHRAGMALYSIS

(71) Applicant: SYBARIS GMBH, Weiden (DE)

(72) Inventors: Manuel Czech, Donaustauf (DE); Andre Philipps, Regensburg (DE); Michael Saefkow, Weinsberg (DE)

(73) Assignee: SYBARIS GMBH, WEIDEN (DE)

(21) Appl. No.: 14/098,584

(22) Filed: Dec. 6, 2013

Related U.S. Application Data
(63) Continuation of application No. 12/933,239, filed on Apr. 1, 2011, now abandoned.

(30) Foreign Application Priority Data
Mar. 19, 2008 (DE) 10 2008 015 068.1

(51) Int. Cl. C01B 5/00; C02F 1/461

(52) U.S. Cl. CPC C01B 5/00; C02F 1/461
USPC 423/580.1; 205/742; 210/668

(57) ABSTRACT

Electrochemically-treated water having an electron deficiency is described, which may be attained by a process comprising the following steps:

a) Electrolysing water,

b) Withdrawing a portion of the catholyte from the system, and

c) Introducing the remaining catholyte into the anodic chamber.

This application is a continuation application of U.S. patent application Ser. No. 12/933,239, filed Sep. 17, 2010 and now abandoned, which is the U.S. National Stage of PCT International Application Number PCT/EP2009/0053255, filed Mar. 19, 2009, which, in turn, claims priority to German Patent Application Number 10 2008 015 068.1, filed Mar. 19, 2008. The contents of the foregoing applications are incorporated herein by reference.

Electrolysis denotes that aspect of electrochemistry which is concerned with phenomena, which arise if chemicals are treated with electric current (in contrast to galvanlcs which recovers chemicals from electric current). Electrolysis includes in its scope the excitation of electrons (luminescence of gases) at low current intensities up to destruction (lysis) at high current intensities.

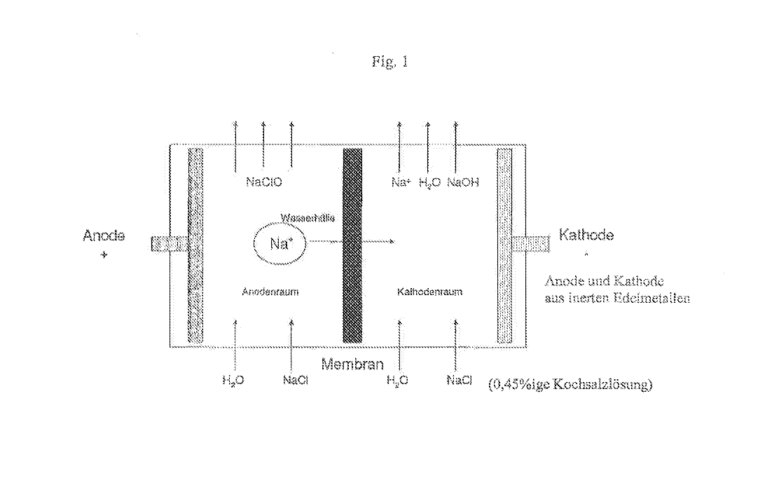

FIG. 1 is a graph illustrating conventional electrodiaphragmalysis.

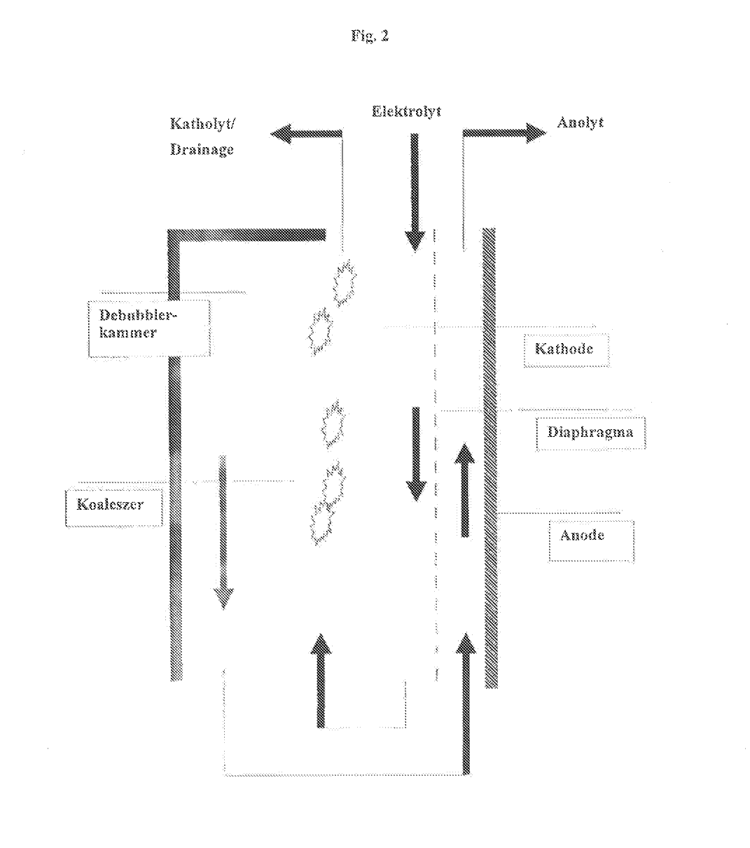

FIG. 2 is a graph illustrating electrodiaphragmalysis in the present invention.

In electrodiaphragmalysis a porous membrane is positioned between the anodic and cathodic regions, which membrane is intended to prevent a passage and intermingling of the gases formed at the anode and at the cathode. These gases (oxygen and chlorine gas at the anode and hydrogen at the cathode), if they come together, form explosive mixtures: oxygen and hydrogen, the so-called oxyhydrogen gas, chlorine gas and hydrogen gas, the so-called chlorine hydrogen explosive gas. The diaphragm accordingly acts as a protection against explosion, which was introduced as long ago as 1886. The alternative method is the amalgam process, in which the cathode consists of mercury which flows through, and which entrains the separation products formed thereon. Because of exposed mercury not a practicable possibility.

According to the state of the art, the anodic and cathodic spaces are each simultaneously and in the same direction of flow subjected to a flow there through of the same electrolyte; see DVGW Working Sheet W229 and FIG. 1). The diaphragm permits the separate recovery of two partial flows (anodic fraction=anolyte and cathodic fraction=catholyte).

The product according to the invention has a higher efficacy against micro-organisms than is to be expected in view of its content of chemical substances (sodium hypochlorite). This is due to its oxidative power, the property to act as an electron acceptor, which, in turn, is due to a high electron deficiency in the water matrix (duster). The latter is attained by a special version of electrodiaphragmalysis.

In this context, water is subjected to a weak electric current intensity. For this purpose, common salt, for example, is added to the water in order to maintain the conductivity of the water In an optimal range for the process. The added quantities are approximately 0.2 to 0.6% or 2 to 6 gil. Plate electrodes are used which generate between them a homogenous field of parallel field lines, such that the field strength in the interspace is uniform throughout. This gives rise to a homogenous, very limited electrolysis in the sense of electron excitation. The electrolyte is conducted at a constant flow velocity of e.g. 140 l/h (based on a 100 l/h production cell), initially through the cathodic space formed by the cathode and the diaphragm. The treatment proceeds preferably at 15-30 amperes. There is formed an alkaline catholyte while a strong gas formation takes place, particularly of hydrogen gas. The cathodic fraction is then passed into a larger space serving for degassing. Due to the sudden expansion of the space a reduction of the flow velocity takes place and the gas bubbles can separate. This process is supported by structures in the liquid flow, such as e.g. honeycombs, acting as coalescing means; see accompanying FIG. 2.

Between 10% and 50%, as a rule 30% of the catholyte, is flushed out by the gas bubbles and leaves the system by way of the drainage means. The residual 50 to 90% are passed into the anodic chamber, such that they pass through the latter in counter-current to the cathodic chamber. The pH value is thereby adjusted to pH 7. The excited electrons pass through the diaphragm into the cathodic space; the electron-deficient anolyte fraction may be recovered.

The process according to the invention is based on a further development of the process of electrolysis. By means of common salt a defined conductivity is attained in the water. By applying a pre-determined voltage in the electrolysis cell, as well as by adjusting other important parameters during the production, the water clusters (coherent water molecules due to the magnetic action of the water molecule dipole) are electrically-discharged.

Positively-charged water clusters are formed which function as electron acceptors, the so-called electron deprivation. This seeks saturation from an electron donor, e.g. any form of single-cell organism.

The process differs drastically from classic electrolysis, on which e.g. the manufacture of chlorine dioxide is based. in that case, an existing electrolyte is subjected to lysis, that is to say separated and chemically-split into radicals.

The kind of electrodiaphragmalysis employed, e.g. for the manufacture of sodium hypochlorite and other oxidising agents, is likewise such a chemically-splitting process. The effect is based on the resulting chlorine chemistry, which in this application situation reacts oxidatively on the environment.

The efficacy of the invention is based on the excitation of the water molecule as such. This is present in a cluster aggregation, such that by the application of a particular current intensity, water molecules become electrically-discharged (similarly to what happens in a neon tube, which by excitation of the electrons of the noble gas is rendered luminescent). In contrast to conventional electrolytic processes, which as a proven method have by now been applied for more than 120 years in a variety of modifications, the water molecule during manufacture according to the invention is not split into its integers Off and H and remains pH-neutral (pH 7.0). The water molecule remains intact and interchanges the charge carriers within the cluster continuously.

Admittedly, during the manufacture small amounts of sodium hypochlorite are formed, however these contaminants of the water (0.6 to 600 ppm depending on concentration) are tolerable in most practical applications.

For very sensitive applications the above-described process can also be applied to the manufacture of products which no longer contain any chlorine-based residual substances, but consist exclusively of water and fractions of excited water molecules.

### Demonstration of Electron Deficiency as an Oxidising Biocide Active Substance

X-ray irradiation provides a potent electron injection. This has no effect on e.g. a hypochlorite solution which does not thereby lose its microbiocidal activity. By way of contrast, the product according to the invention loses its biocidal effect entirely by X-ray irradiation.

### Experiment 1

It was observed that trial solutions, which had been transported en an aircraft, had no efficacy. The following experiment was then conducted. Solution A was subjected to an X-ray dosage as would be effective during a 1-hour flight from Frankfurt to Berlin. The eradication of E. coli was tested for in a microbiolegical laboratory. The control sample was not X-rayed, but took part in the trips of solution A from Regensburg to. Wiesbaden and from there to the testing laboratory.

Zeit

| | Konz. | 1 min | 5 min |
|---|---|---|---|
| Kontrolle | 10% | − | − |
| | 30% | − | − |
| | 50% | − | − |
| Lösung A | 10% | + | + |
| | 30% | + | + |
| | 50% | + | + |

+ = growth of the test microbe (proof by sub-culture)
− = no growth

Testing microbe: Escherichia coil

Starting microbe count: 2.3×10⁴

The control, even in only 10% solution, killed all microbes within only 1 minute; there was no growth. Transport had had no effect on the efficacy.

Solution A, even in a 50% concentration, showed no effect after 5 minutes of interaction, thus having been deactivated entirely by the electron influx during X-ray irradiation.

### Experiment 2

The fresh product according to the invention in a 10% solution includes 25 ppm hypochlorite (NADES).

NADES SC as shown in the following Table is a 10% NADES product from which the hypochlorite had been withdrawn entirely to <0.02 ppm. A hypochlorite solution of such concentration has no microbiocidal effect. Nevertheless, the redox potentials of both solutions were nearly identical, in any event clearly above the level of 600 ppm demanded for sanitising swimming pool water.

| jeweils 10% | | ppm in | Effektive | KBE nach 4 |
|---|---|---|---|---|
| von | Redoxpotential | Konzentrat | ppm | Tagen |
| NADES frisch | 820 | 250 | 25 | 0/0 |
| NADES SC | 750 | 0.2 | 0.02 | 0/0 |

The microbiocidal effect of both solutions was identical; there was no growth, not even after 4 days. Proof for the efficacy of the electron deficiency.

1. Electrochemically-treated water having an electron deficiency, attainable by a process which is characterised by the following steps:
a) Electrolysing water,
b) Withdrawing a portion of the catholyte from the system, and
c) Introducing the remaining catholyte into the anodic chamber.

2. Electrochemically-treated water according to claim 1, characterised by a disinfecting action against bacteria, bacterial spores, fungi, fungal spores, viruses, prions, single-cell algae or mixtures thereof.

3. Electrochemically-treated water according to claim 1, wherein the electrochemically-treated water is characterized by an overall concentration of oxidizing agents formed by step a) of less than 600 ppm.

4. Electrochemically-treated water according to claim 3, characterised by an overall concentration of oxidising agents of less than 20 ppm.

5. Electrochemically-treated water according to claim 4, characterised by an overall concentration of oxidising agents of less than 2 ppm.

6. Electrochemically-treated water according to claim 1, characterised in that the content of chlorine-containing oxidising agents, peroxides and ozone is less than 0.02 ppm each.

7. Electrochemically-treated water according to claim 1, characterised in that it is essentially free of oxidising agents.

8. Electrochemically-treated water according to claim 7, characterised in that during step b) the oxidising agents are removed by a suitable sorbent.

9. Electrochemically-treated water according to claim 8, characterised in that the sorbent is selected from activated charcoal, aluminium oxide, silicon oxide, ion exchangers, zeolithe or mixtures thereof.

10. Electrochemically-treated water according to claim 1, characterised in that to the water starting material to be electrolysed according to step a) salts are added in order to increase the conductivity.

11. Electrochemically-treated water according to claim 10, characterised in that the water starting material to be electrolysed in step a) contains sodium chloride.

12. Electrochemically-treated water according to claim 1, characterised in that in step a) the electrolysis is performed at a current density of 0.5 to 10 W/cm².

13. Electrochemically-treated water according to claim 1, characterised in that the process is performed continuously.

14. Electrochemically-treated water according to claim 10, wherein the added salts are selected from alkali metal cations and halogen-containing anions, sulphur-containing anions, phosphorus-containing anions, carboxylates, carbonates and mixtures of such anions.
